(19) United States
(12) Patent Application Publication
(10) Pub. No.: US 2005/0129895 A1
(43) Pub. Date: Jun. 16, 2005

(54) Adhesive film and prepreg

(75) Inventor: Shigeo Nakamura, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: AJINOMOTO CO., INC., Tokyo (JP)

(21) Appl. No.: 10/996,446

(22) Filed: Nov. 26, 2004

Related U.S. Application Data
(63) Continuation of application No. PCT/JP03/06562, filed on May 26, 2003.

(30) Foreign Application Priority Data
May 27, 2002 (JP) 2002-152489

(51) Int. Cl. B32B 3/00; B32B 9/00

(52) U.S. Cl. 428/40.1; 428/209; 428/416; 156/247

(57) ABSTRACT

Adhesive films in which an epoxy resin composition comprising the following components (A) to (C): (A) an aromatic epoxy resin having two or more epoxy groups in a molecule; (B) a cyanate compound having two or more cyanato groups in a molecule; and (C) a phenoxy resin having a weight average molecular weight of from 5,000 to 100,000, is laminated on a support film, and a prepreg in which a sheet-like reinforcing base material made of a fiber is impregnated with the epoxy resin composition comprising the components (A) to (C) are excellent for forming insulation layers in multilayer printed circuit boards.

### CROSS REFERENCES TO RELATED APPLICATIONS

This application is a continuation of International Patent Application No. PCT/JP03/06562, filed on May 26, 2003, and claims priority to Japanese Patent Application No. 2002-152489, filed on May 27, 2002, both of which are incorporated herein by reference in their entireties.

### BACKGROUND OF THE INVENTION

1. Field of the Invention

The present invention relates to adhesive films and prepregs which are useful as electrical insulation materials. The present invention particularly relates to adhesive films and prepregs which are useful as interlaminar insulation materials of multilayer printed circuit boards. The invention further relates to multilayer printed circuit boards in which an insulation layer is formed of such an adhesive film or prepreg and a process for producing such a multilayer printed circuit board.

2. Discussion of the Background

In recent years, higher processing speeds and higher wiring densities have been strongly required, for printed circuit boards used in electronic appliances, communications apparatus, and the like. Accordingly, as a process for producing a multilayer printed circuit board, a production technique of a build-up system in which an organic insulation layer is alternately stacked on a conductor layer of a circuit substrate has attracted much interest. As an insulation resin currently used in the build-up system, aromatic epoxy resins in combination with curing agents having active hydrogen (for example, a phenolic curing agent, an amine-type curing agent, and a carboxylic acid-type curing agent) have been mainly used. The cured product obtained using these curing agents has well-balanced properties, but suffers from the drawback that a hydroxyl group having a high polarity is generated by the reaction of an epoxy group and active hydrogen which decreases the moisture resistance and electrical properties such as the dielectric constant and the dielectric dissipation factor. Insulation materials having a low dielectric dissipation factor has been required especially for multilayer printed circuit boards used in the high-frequency region. However, in an ordinary insulation material containing an epoxy resin as a main component, the value of the dielectric dissipation factor (1 GHz, 23° C.) has been limited to from approximately 0.03 to 0.02.

Meanwhile, it has been long known that a cyanate compound having a thermosetting cyanato group gives a cured product excellent in dielectric properties. However, since the reaction of forming an S-triazine ring by thermally curing a cyanato group requires, for example, curing at a high temperature of 230° C. for a relatively long time of more than 2 hours, the cyanate compound is hardly used as an insulation material for a general FR4 substrate (glass transition point approximately 135° C.).

As a method of decreasing the curing temperature of a cyanate compound, a method in which a cyanate compound is used in combination with an epoxy resin and cured using a curing catalyst is known. In this method, the reaction in which an epoxy group of the epoxy resin is reacted with a cyanato group of the cyanate compound to form an oxazoline ring is a main reaction, and generation of hydroxyl groups that increase the dielectric dissipation factor or the persistance of cyanato groups that likewise increase the dielectric dissipation factor is inhibited after thermal curing.

As the curing catalyst of the cyanate compound, a phenolic compound and an organometallic compound are known. However, the use of a phenolic compound as the curing catalyst has been problematic in that the storage stability (pot life) of the resin composition is heavily impaired after a heat-drying step in the production of an adhesive film or a prepreg. Further, in a system using an organometallic compound, the gel time in thermal curing is greatly influenced by a trace amount of a catalyst which is several hundreds of ppm, and controlling the gel time is thus difficult. Accordingly, it has not necessarily been said to be suitable for industrial production.

Thus, there remains a need for adhesive films and prepregs which are produced with a system using an epoxy resin and a cyanate compound, which provide excellent electrical properties in the cured product, which exhibit excellent curing properties and excellent pot life, and which are suitable for industrial production of a multilayer printed circuit board.

### SUMMARY OF THE INVENTION

Accordingly, it is one object of the present invention to provide novel adhesive films and prepregs.

It is another object of the present invention to provide novel adhesive films and prepregs which provide excellent electrical properties in the cured product.

It is another object of the present invention to provide novel adhesive films and prepregs which exhibit excellent curing properties.

It is another object of the present invention to provide novel adhesive films and prepregs which exhibit excellent pot life.

It is another object of the present invention to provide novel adhesive films and prepregs which are suitable for industrial production of a multilayer printed circuit board.

These and other objects, which will become apparent during the following detailed description, have been achieved by the inventor's discovery that the above-mentioned problems are solved by an adhesive film and a prepreg which comprise a specific epoxy resin, a specific cyanate compound, and a specific phenoxy resin. This finding has led to the completion of the invention.

Thus, the present invention provides the following:

(1) An adhesive film, comprising a layer of an epoxy resin composition which comprises the following components (A) to (C) is formed on a support film;

(A) an aromatic epoxy resin having two or more epoxy groups in a molecule;

(B) an aromatic cyanate compound having two or more cyanato groups in a molecule; and

(C) a phenoxy resin having a weight average molecular weight of from 5,000 to 100,000.

(2) The adhesive film recited in (1), in which the phenoxy resin as component (C) is a phenoxy resin having a biphenyl skeleton.

(3) The adhesive film recited in (1) and (2), in which the epoxy resin composition after thermal curing has a dielectric dissipation factor of 0.015 or less as determined by measurement conditions of a measurement frequency of 1 GHz and a temperature of 23° C.

(4) The adhesive film recited in (1) to (3), in which the ratio between the epoxy groups of the aromatic epoxy resin as component (A) and the cyanato groups of the aromatic cyanate compound as component (B) in the epoxy resin composition is from 1:0.5 to 1:3, and the phenoxy resin as component (C) is present in an amount of from 3 to 40 parts by weight per 100 parts by weight of the total weight of components (A) and (B).

(5) A multilayer printed circuit board in which an insulation layer is formed of the adhesive film recited in (1) to (4).

(6) A process for producing a multilayer printed circuit board, comprising:

(a) laminating the adhesive film recited in (1) to (4) on a circuit substrate under pressing and heating conditions;

(b) removing the support film as required;

(c), thermally curing the epoxy resin composition laminated on the circuit substrate to form an insulation layer;

(d) removing the support film as required in case the support film has not yet been removed;

(e) roughening the surface of the insulation layer with an oxidizing agent as required; and

(f) forming a conductor layer by plating.

(7) A multilayer printed circuit board which is obtained by the process recited in (6).

(8) A prepreg comprising a sheet-like reinforcing base material made of a fiber which is impregnated with the epoxy resin composition comprising the following components (A) to (C);

(A) an aromatic epoxy resin having two or more epoxy groups in a molecule;

(B) an aromatic cyanate compound having two or more cyanato groups in a molecule; and

(C) a phenoxy resin having a weight-average molecular weight of from 5,000 to 100,000.

(9) The prepreg recited in (8), in which the phenoxy resin as component (C) is a phenoxy resin having a biphenyl skeleton.

(10) The prepreg recited in (8) and (9), in which the epoxy resin composition after thermal curing has a dielectric dissipation factor of 0.015 or less as determined by measurement conditions of a measurement frequency of 1 GHz and a temperature of 23° C.

(11) The prepreg recited in (8) to (10), in which the ratio between the epoxy groups of the aromatic epoxy resin as component (A) and the cyanato groups of the aromatic cyanate compound as component (B) in the epoxy resin composition is from 1:0.5 to 1:3, and the phenoxy resin as component (C) is present in an amount of from 3 to 40 parts by weight per 100 parts by weight based on the total weight of components (A) and (B).

(12) A multilayer printed circuit board in which an insulation layer is formed of the prepreg recited in (8) to (11).

(13) A process for producing a multilayer printed circuit board, comprising:

(a) laminating the prepreg recited in (8) to (11) on a circuit substrate under pressing and heating conditions to form an insulation layer;

(b) roughening the surface of the insulation layer with an oxidizing agent as required; and

(c) forming a conductor layer by plating.

(14) A multilayer printed circuit board which is obtained by the process recited in (13).

### BRIEF DESCRIPTION OF THE DRAWINGS

A more complete appreciation of the invention and many of the attendant advantages thereof will be readily obtained as the same become better understood by reference to the following detailed description when considered in connection with the accompanying drawings, wherein:

FIG. 1 shows the results of the measurement of the dynamic viscoelasticity of three epoxy resin compositions constituting the adhesive films obtained in Examples 1 and 2 and Comparative Example 2, wherein:

1. η=Melt viscosity (poise);

2. ◯, Example 1;

3. α, Example 2;

4. □, Comparative Example 2; and

5. Temperature (° C.).

FIG. 2 shows the results of the measurement of the dynamic viscoelasticity of epoxy resin compositions constituting the adhesive film obtained in Comparative Example 3 before and after storage at room temperature for 3 days, wherein:

1. η=Melt viscosity (poise);

2. □, Comparative Example 3 before storage; and

3. ◯, Comparative Example 3 after storage.

### DETAILED DESCRIPTION OF THE PREFERRED EMBODIMENTS

The invention is described in detail below.

In the present invention, the term “an aromatic epoxy resin having two or more epoxy groups in a molecule” as component (A) refers to an epoxy resin having two or more epoxy groups in the molecule and having an aromatic ring skeleton in the molecule. Preferred examples of the aromatic epoxy resin having two or more epoxy groups in the molecule include a bisphenol A-type epoxy resin, a bisphenol F-type epoxy resin, a bisphenol S-type epoxy resin, a phenol novolak-type epoxy resin, an alkylphenol novolak-type epoxy resin, a biphenyl-type epoxy resin, a dicyclopentadiene-type epoxy resin, an epoxidized condensate of phenols and aromatic aldehydes having a phenolic hydroxyl group, a naphthalene-type epoxy resin, triglycidyl isocyanurate, those epoxy resins which are brominated or phosphorus-modified, and the like. These epoxy resins may be used either singly or in combination of two or more thereof.

In the present invention, the term “an aromatic cyanate compound having two or more cyanato groups in a molecule” as component (B) refers to a cyanate compound having two or more cyanato groups in the molecule and having an aromatic ring skeleton in the molecule. Preferred examples of the aromatic cyanate compound having two or more cyanato group in the molecule include bisphenol A diisocyanate, polyphenol cyanate (oligo(3-methylene-1,5-phenylene cyanate), 4,4′-methylenebis (2,6-dimethylphenyl cyanate), 4,4′-ethylidenediphenyl dicyanate, hexafluorobisphenol A dicyanate, prepolymers obtained by partially triazinating these compounds, and the like. These cyanate compounds may be used either singly or in combination of two or more thereof.

The ratio between the epoxy groups present in a molecule of component (A) and the cyanato groups present in a molecule of component (B) in the epoxy resin composition is preferably from 1:0.5 to 1:3. When the ratio is deviated from this range, a sufficiently low dielectric dissipation factor value might not be obtained owing to unreacted epoxy groups or cyanato groups remaining after curing. When the epoxy resin composition further contains an epoxy group-containing compound other than component (A) or a cyanato group-containing compound other than component (B), the ratio between the total epoxy groups and the total cyanato groups including those of these compounds is also set in the foregoing range. That is, it is preferred that the ratio between all the epoxy groups and all the cyanato groups present in the epoxy resin composition is from 1:0.5 to 1:3.

Next, the “a phenoxy resin having a weight average molecular weight of from 5,000 to 100,000” as component (C) is described.

The phenoxy resin is a polymer comprising a reaction product of a difunctional epoxy resin and a bisphenol compound. It is considered that since a hydroxyl group present in a molecule acts to accelerate curing of an epoxy group and a cyanato group, satisfactory curing properties (heat resistance, low dielectric dissipation factor, and the like) can be obtained at a relatively low curing temperature. It is known that when an epoxy resin has a hydroxyl group in a resin composition comprising a cyanate compound and the epoxy resin, a curing acceleration activity is observed, but the hydroxyl group decreases the pot life of the resin composition. Meanwhile, the present inventor has found that when components (A) and (B) are used in combination with a polymeric phenoxy resin as component (C), excellent curing properties are exhibited without decreasing the pot life of the epoxy resin composition. It has been further found that the addition of the phenoxy resin as component (C) improves the roughening property of the cured epoxy resin product with an oxidizing agent to allow formation of a conductor layer by plating.

Preferred examples of the phenoxy resin having the weight average molecular weight of from 5,000 to 100,000 include bisphenol A-type Phenotohto YP50 (manufactured by Tohto Kasei Co., Ltd.), E-1256 (manufactured by Japan Epoxy Resins Co., Ltd.), Phenotohto YPB40 (manufactured by Tohto Kasei Co., Ltd.) as the brominated phenoxy resin and the like.

As component (C), a phenoxy resin having a bisphenol skeleton and having a weight-average molecular weight of from 5,000 to 100,000 is preferred in view of heat resistance, moisture resistance, and curing acceleration activity. Specific examples of the phenoxy resin include YL6742BH30, YL6835BH40, YL6953BH30, YL6954BH30, YL6974BH30, and YX8100BH30, which are phenoxy resins comprising reaction products of a biphenyl-type epoxy resin (YX4000 manufactured by Japan Epoxy Resins Co., Ltd.) and various bisphenol compounds.

These phenoxy resins may be used either singly or in combination of two or more thereof.

The phenoxy resin having a weight-average molecular weight of from 5,000 to 100,000 improves the curing acceleration activity and the flexibility of the adhesive film and the prepreg to make the handling thereof easy, and also improves the mechanical strength and flexibility of the cured product. Further, it enables the roughening of the cured product with an oxidizing agent. Incidentally, when the weight-average molecular weight of the resin as component (C) is less than 5,000, the foregoing effects are insufficient. When it exceeds 100,000, the dissolution in the epoxy resin in an organic solvent is extremely decreased which makes the actual use thereof difficult.

The mixing amount of the resin as component (C) varies with its type. It is preferably from 3 to 40 parts by weight per 100 parts by weight of the total weight of the epoxy resin as component (A) and the cyanate compound as component (B). Especially, it is preferably mixed in the range of from 5 to 25 parts by weight per 100 parts by weight of the total weight of the epoxy resin as component (A) and the cyanate compound as component (B). When it is less than 3 parts by weight, the curing acceleration activity of the resin composition might be insufficient. When the resin composition is laminated on the circuit substrate or the laminated resin composition is thermally cured, the thickness of the insulation layer tends to be non-uniform owing to too high a fluidity of the resin. Further, a sufficient roughening property of the cured product for formation of the conductor layer is difficult to obtain. Meanwhile, when the amount of the resin as component (C) exceeds 40 parts by weight, the functional group of the phenoxy resin is present in an excess, and a sufficiently low dielectric dissipation factor value is difficult to obtain. Moreover, since the fluidity when laminating the resin composition on a circuit substrate is too low, it is difficult to satisfactorily fill the resin in via holes or through-holes present in the circuit substrate.

The total content of components (A) to (C) in the epoxy resin composition of the invention is not particularly limited. They are usually contained in an amount of from 25% by weight to 90% by weight, when the epoxy resin composition is defined as 100% by weight.

Any organometallic compound which is ordinarily used as a curing catalyst in a system using a combination of an epoxy resin composition and a cyanate compound may be added, as required, to the epoxy resin composition of the present invention, for further shortening the curing time. When the organometallic compound was used in conventional systems, the gel time in thermal curing was highly influenced by even a trace amount of the organometallic compound being several hundreds of ppm, and control of the gel time was difficult. In contrast, in the epoxy resin composition of the present invention, the organometallic compound only serves to aid in the curing. Accordingly, when the organometallic catalyst is added, the gel time can be controlled relatively easily, which makes it possible to provide adhesive films and prepregs which are suitable for industrial production of multilayer printed circuit boards. Examples of such an organometallic compound include organocopper compounds such as copper (II) acetylacetonate, organozinc compounds such as zinc (II) acetylacetonate, organocobalt compounds such as cobalt (II) acetylacetonate and cobalt (III) acetylacetonate, and the like. When the organometallic compound is added, the addition amount is usually from 10 to 500 ppm, preferably from 25 to 200 ppm, calculated as metal, based on the “aromatic cyanate compound having two or more cyanato groups in a molecule” as component (B).

In the epoxy resin composition of the present invention, an inorganic filler may be added for decreasing a thermal expansion coefficient of the insulation layer formed as required. When an inorganic filler is added, the addition amount varies with the properties desired or a required performance of the epoxy resin composition in the invention. When the amount of the epoxy resin composition is defined as 100% by weight, the inorganic filler is typically mixed in an amount of, usually from 10 to 75% by weight, preferably from 20 to 65% by weight.

Examples of the inorganic filler include silica, alumina, barium sulfate, talc, clay, mica powder, aluminum hydroxide, magnesium hydroxide, calcium carbonate, magnesium carbonate, magnesium oxide, boron nitride, aluminum borate, barium titanate, strontium titanate, calcium titanate, magnesium titanate, bismuth titanate, titanium oxide, barium zirconate, calcium zirconate and the like. Silica is especially preferable. An inorganic filler having an average particle size of 5 μm or less is preferable. When the average particle size exceeds 5 μm, it is sometimes difficult to stably form a fine pattern when forming a circuit pattern on the conductor layer. An inorganic filler which is surface-treated with a surface treating agent such as a silane coupling agent for improving a moisture resistance is preferable.

In the epoxy resin composition of the present invention, besides the components, other thermosetting resins or thermoplastic resins and additives can be used, as required, unless the effects of the invention are impaired. Examples of such thermosetting resins include a monofunctional epoxy resin as a diluent, an alicyclic polyfunctional epoxy resin, a rubber-modified epoxy resin, an acid anhydride-type compound, a blocked isocyanate resin and a xylene resin as an epoxy resin curing agent, a polymerizable resin as a radical generating agent, and the like. Examples of the thermoplastic resin include a polyimide resin, a polyamideimide resin, a polyether imide resin, a polysulfone resin, a polyether sulfone resin, a polyphenylene ether resin, a polycarbonate resin, a polyether ether ketone resin, a polyester resin, and the like. Examples of the additives can include organic fillers such as a silicone powder, a nylon powder and a fluorine powder, thickening agents such as orben and benton, silicone-based, fluorine-based and polymeric defoamers or leveling agents, adhesion imparting agents such as imidazole, thiazole, triazole and silane coupling agents, colorants such as phthalocyanine blue, phthalocyanine green, iodine green, disazo yellow and carbon black, and the like.

The epoxy resin composition of the present invention can form a cured product which is excellent in heat resistance and electrical properties. For example, a cured product can be formed which meets a condition of a dielectric dissipation factor (for example, 0.015 or less under conditions of a measurement frequency of 1 GHz and a temperature of 23° C.) required for a printed circuit board used in a high-frequency region.

The adhesive film of the invention is described below.

The adhesive film of the invention can be produced by dissolving the epoxy resin composition comprising the foregoing (A) to (C) as essential components in an organic solvent to form a resin varnish, coating this varnish on a base film (support film) and drying the solvent by a step of hot air blowing or the like.

Examples of the organic solvent include ketones such as acetone, methyl ethyl ketone, and cyclohexanone; acetate esters such as ethyl acetate, butyl acetate, cellosolve acetate, propylene glycol monomethyl ether acetate, and carbitol acetate; carbitols such as cellosolve and butyl carbitol; aromatic hydrocarbons such as toluene and xylene; dimethylformamide; dimethylacetamide; N-methylpyrrolidone; and the like. The organic solvents may be used in combination of two or more thereof.

A skilled person can determine preferable drying conditions, as required, by a simple experiment. For example, a varnish containing from 30 to 60% by weight of the organic solvent can be dried at from 80 to 100° C. for from 3 to 10 minutes. The amount of the organic solvent remaining in the epoxy resin composition is usually 10% by weight or less, preferably 5% by weight or less, based on the total weight of the composition.

In the adhesive film of the present invention, the epoxy resin composition layer constituting the adhesive layer has a melt viscosity property suitable for use in a vacuum lamination method. That is, the adhesive film of the invention is preferably an adhesive film which is softened under a temperature condition of vacuum lamination (usually from 70° C. to 140° C.) to show a fluidity and, when via holes or through-holes are present, allows the resin to be filled in these holes at the same time in vacuum lamination. Such a melt viscosity property is disclosed in WO 01/97582, and can be determined according to a temperature-melt viscosity curve obtained by measuring a Japan Epoxy Resins Co., Ltd. of the epoxy resin composition. A measurement starting temperature is set at 60° C., and heating is conducted at a rate of temperature rise of 5° C./min to measure a melt viscosity and obtain a temperature-melt viscosity curve. At this time, an adhesive film showing a melt viscosity value at each temperature as listed in Table 1 meets the foregoing properties, and is a preferred.

TABLE 1

| Temperature (° C.) | Melt viscosity (poise) |
|---|---|
| 90 | 4,000-50,000 |
| 100 | 2,000-21,000 |
| 110 | 900-12,000 |
| 120 | 500-9,000 |
| 130 | 300-15,000 |

A skilled person can easily produce, as required, an adhesive film having a melt viscosity property suitable for a vacuum lamination method by reference to the present description of the epoxy resin composition and the adhesive film of the present invention and the disclosure of WO 01/97582.

In the adhesive film of the present invention, the epoxy resin composition is preferably laminated on a support film having a thickness of from 10 to 200 μm to a thickness which is larger than the thickness of the conductor in the circuit substrate to be laminated and preferably from 10 to 150 μm.

A protective film corresponding to the support film can further be laminated on the surface of the epoxy resin composition layer to which the support film is not adhered. The thickness of the protective layer is preferably from 1 to 40 μm. The protection with the protective film can prevent adhesion of dust or the like to the surface of the epoxy resin composition layer or damage of this surface. The adhesive film may be stored by being wound in a roll.

Examples of the support film include polyolefins such as polyethylene and polyvinyl chloride; polyesters such as polyethylene terephthalate (hereinafter sometimes abbreviated as “PET”) and polyethylene naphthalate; polycarbonate; polyimide; release paper; metallic foils such as copper foil and aluminum foil; and the like. The support film may be subjected to a mud treatment, a corona treatment, or a release treatment.

Examples of the organic solvent used to prepare the varnish can include ketones such as acetone, methyl ethyl ketone and cyclohexanone; acetate esters such as ethyl acetate, butyl acetate, cellosolve acetate, propylene glycol monomethyl ether acetate, and carbitol acetate; cellosolves such as cellosolve and butyl cellosolve; carbitols such as carbitol and butyl carbitol; aromatic hydrocarbons such as toluene and xylene; dimethylformamide; dimethylacetamide; and the like. These organic solvents may be used either singly or in combination of two or more thereof.

With respect to the substrate used as the circuit substrate, a glass epoxy substrate, a metallic substrate, a polyester substrate, a polyimide substrate, a BT resin substrate, a thermosetting polyphenylene ether substrate, and the like can be used. By the way, the circuit substrate in the present invention refers to the foregoing substrate on which patterned conductor layer(s) (circuit(s)) is (are) formed one or both surfaces. With respect to a multilayer printed circuit board in which a conductor layer and an insulation layer are alternately laminated, the case in which one or both surfaces of the outermost layer on the multilayer printed circuit board is (are) patterned conductor layer(s) (circuit(s)) is also included in the circuit substrate referred to in the invention. The surface of the conductor layer may previously be roughened by a black oxide treatment or the like.

Next, the prepreg of the invention is described.

The prepreg can be produced by dipping a sheet-like reinforcing base material made of a fiber into the epoxy resin composition of the invention by a hot melt method or a solvent method, and semi-curing it through heating. That is, the prepreg can be formed in which the sheet-like reinforcing base material made of the fiber is dipped into or impregnated with the epoxy resin composition.

As the sheet-like reinforcing base material made of the fiber, a fiber ordinarily used as a prepreg fiber, such as a glass cloth or an aramid fiber, can be used.

The hot melt method is a method in which a prepreg is produced by once coating a resin on a coated paper having a good peelability from the resin without dissolving the resin in an organic solvent and laminating the resulting paper on a sheet-like reinforcing base material or directly coating it with a die coater. The solvent method is a method in which a sheet-like reinforcing base material is impregnated with a resin varnish obtained by dissolving a resin in an organic solvent, by dipping the sheet-like reinforcing base material into the resin varnish, and then drying the resulting product, as in the adhesive film. In this case, the drying conditions are the same as those in the adhesive film.

The process for producing the multilayer printed circuit board of the present invention using the adhesive film of the present invention is described below.

The adhesive film of the present invention can properly be laminated on the circuit substrate with a vacuum laminator. In the lamination, when the adhesive film has the protective film, the protective film is removed, and the adhesive film is then pressed on the circuit substrate while being pressed and heated. In regard to the conditions of lamination, it is advisable that the adhesive film and the circuit substrate are preheated as required, and the lamination is conducted at a press temperature of, preferably from 70 to 140°, and a press pressure of, preferably from 1 to 11 kgf/cm², under reduced air pressure of 20 mmHg or less. The lamination method may be batchwise or continuous with a roll. After the lamination, the support film is removed as required after the temperature is reduced to approximately room temperature, and the epoxy resin composition laminated on the circuit substrate is thermally cured. The thermal curing conditions are selected from the range of from 150° C. to 220° C. and from 20 minutes to 180 minutes. Preferable conditions are from 160° C. to 200° C. and from 30 to 120 minutes. When a support film which has been subjected to a release treatment is used, the support film may be removed after the thermal curing. Meanwhile, when a metallic foil is used, the support film can sometimes be used directly as the conductor layer. Thus, the peeling or removing of the support film is sometimes unnecessary.

When the insulation layer is thus formed as a cured product of the epoxy resin composition, the insulation layer may be bored, as required, with a drill, a laser or the like to form via holes or through-holes.

Subsequently, the conductor layer may be formed by dry plating or wet plating. As for dry plating, a known method such as deposition, sputtering, or ion plating can be used. For wet plating, the surface of the cured epoxy resin composition layer (insulation layer) is first roughened with an oxidizing agent such as a permanganate (potassium permanganate, sodium permanganate or the like), a bichromate, ozone, hydrogen peroxide/sulfuric acid or nitric acid to form an uneven surface (“anchor”) for anchoring the conductive layer. As the oxidizing agent, a sodium hydroxide aqueous solution of potassium permanganate, sodium permanganate, or the like (alkaline permanganate aqueous solution) is preferably used. Then, the conductor may be formed by a method which is a combination of electroless plating and electroplating. It is also possible that a plating resist having an opposite pattern to that of the conductor layer is formed and the conductor layer is formed by electroless plating alone. As the subsequent patterning method, for example, a subtractive method or a semi-additive method which is known to a skilled person can specifically be used.

The process for producing the multilayer printed circuit board of the present invention using the prepreg of the invention is described below.

As a method in which the prepreg of the present invention is laminated on the circuit substrate, for example, a method is mentioned in which one prepreg is put on, or, as required, a plurality of prepregs are overlaid, a metallic plate is disposed thereon through a release film and they are laminated with a lamination press under pressing and heating conditions. In this case, it is advisable that the lamination of the prepreg(s) on the circuit substrate and the curing thereof are conducted simultaneously and the lamination and the curing are conducted at a pressure of, preferably from 5 to 40 kgf/cm², and a temperature of, preferably from 120 to 220° C., for from 30 to 180 minutes. Similarly to the foregoing adhesive film, the prepreg(s) can be laminated on the circuit substrate with a vacuum laminator and then thermally cured.

In this manner, the multilayer printed circuit board can be produced by forming the insulation layer as the cured product of the prepreg(s) on the circuit substrate, then forming the via holes or the through-holes in the insulation layer as required in the foregoing manner, roughening the surface of the insulation layer, and then forming the conductor layer through plating. The lamination is conducted such that the metallic foil such as a copper foil is held between the release film and the prepreg, whereby the metallic foil can be used directly as the conductor layer.

Other features of the invention will become apparent in the course of the following descriptions of exemplary embodiments which are given for illustration of the invention and are not intended to be limiting thereof.

### EXAMPLES

### Example 1

30 parts by weight of a bisphenol A-type epoxy resin (epoxy equivalent 175, Epikote 825 manufactured by Japan Epoxy Resins Co.) as component (A); 60 parts by weight of a prepolymer of bisphenol A dicyanate (BA230S75 of Lonza Japan Ltd., methyl ethyl ketone (MEK) varnish with a cyanate equivalent of approximately 232 and a nonvolatile content of 75%) as component (B); 40 parts by weight of a phenoxy resin varnish having a bisphenol skeleton (YL6954BH30 manufactured by Japan Epoxy Resins Co., MEK/cyclohexanone varnish with a weight-average molecular weight of 38,000 and a nonvolatile content of 30%) as component (C); and 30 parts by weight of spherical silica were added together to produce an epoxy resin composition. The epoxy resin composition in the form of the varnish was coated on a PET film having a thickness of 38 μm with a die coater such that the thickness after drying became 60 μm, and dried at a temperature of from 80 to 120° C. for a time of 10 minutes to obtain an adhesive film (residual solvent from approximately 1 to 2% by weight).

### Example 2

An epoxy resin composition which was exactly the same as in Example 1, except that the phenoxy resin as component (C) described in Example 1 was changed to 30 parts by weight of a bisphenol A-type phenoxy resin varnish (E1256B40 manufactured by Japan Epoxy Resin K.K., MEK varnish with a weight-average molecular weight of 48,000 and a nonvolatile content of 40%), was coated on a PET film having a thickness of 38 μm with a die coater such that the thickness after drying became 60 μm, and dried at a temperature of from 80 to 120° C. for a time of 10 minutes to obtain an adhesive film (residual solvent from approximately 1 to 2% by weight).

### Example 3

A glass cloth was dipped with the varnish of the epoxy resin composition described in Example 1, and dried at a temperature of 150° C. for a time of 8 minutes to obtain a prepreg having a thickness of 0.1 mm (content of the epoxy resin composition in the prepreg 45% by weight, residual solvent from approximately 1 to 2% by weight).

### Comparative Example 1

An epoxy resin composition which was exactly the same as the epoxy resin composition described in Example 1, except that the phenoxy resin as component (C) was absent, was coated on a PET film having a thickness of 38 μm with a die coater such that the thickness after drying became 60 μm, and dried at a temperature of from 80 to 120° C. for a time of 10 minutes. However, resin cissing (pinhole) was observed in part of the film, because the viscosity was too low during the drying, and the surface of the resin was viscous even after drying. Accordingly, a film capable of enduring the use as an adhesive film could not be produced.

### Comparative Example 2

An epoxy resin composition which was exactly the same as in Example 1, except that the phenoxy resin as component (C) was changed to 60 parts by weight of N,N′-dimethylformamide varnish of polysulfone (P-1700 manufactured by Solvey Advanced Polymers K.K.), was coated on a PET film having a thickness of 38 μm with a die coater such that the thickness after drying became 60 μm, and dried at a temperature of from 80 to 120° C. for a time of 10 minutes to obtain an adhesive film (residual solvent from approximately 1 to 2% by weight).

### Comparative Example 3

An epoxy resin composition which was exactly the same as in Example 1, except that the phenoxy resin as component (C) was changed to 10 parts by weight of a phenolic novolak resin (TD2090-60M manufactured by Dainippon Ink and Chemicals Incorporated; MEK varnish with a nonvolatile content of 60%), was coated on a PET film having a thickness of 38 μm with a die coater such that the thickness after drying became 60 μm, and dried at a temperature of from 80 to 120° C. for a time of 10 minutes to obtain an adhesive film (residual solvent from approximately 1 to 2% by weight).

### Example 4

A circuit substrate was produced from an FR4 double-copper-clad laminate having a copper foil thickness of 35 μm and a plate thickness of 0.2 mm. The adhesive film obtained in Example 1 was laminated on both surfaces thereof with a batchwise vacuum laminator under pressing conditions of a temperature of 110° C., a pressure of 5 kgf/cm², an atmospheric pressure of 5 mmHg or less, and a time of 30 seconds. Subsequently, the PET film was peeled, and the product was thermally cured at a temperature of 170° C. for a time of 30 minutes. Then, boring was conducted with a laser to form via holes. The surface of the cured epoxy resin composition was roughened with an alkaline permanganate oxidizing agent, and subjected to electroless plating and electroplating. Patterning was conducted by a subtractive method to obtain a four-layer printed circuit board. Thereafter, an annealing treatment was conducted at 180° C. for 90 minutes. The peel strength of the resulting conductor layer was 0.7 kgf/cm. Incidentally, the peel strength was measured according to Japanese Industrial Standard (JIS) C 6481, and the conductor plating thickness was set at approximately 30 μm. The thus-obtained multilayer printed circuit board was soldered at a temperature of 260° C. for a time of 60 seconds, and the solder heat resistance was observed. Consequently, abnormalities such as delamination of the resin or peeling of the conductor were not found.

### Example 5

A four-layer printed circuit board was obtained in the same manner as in Example 4 using the adhesive film obtained in Example 2. The peel strength of the resulting conductor layer was 0.8 kgf/cm. The thus-obtained multilayer printed circuit board was soldered at a temperature of 260° C. for a time of 60 seconds, and the solder heat resistance was observed. Consequently, abnormalities such as delamination of the resin or peeling of the conductor were not found.

### Example 6

Two prepregs obtained in Example 3 were overlaid, and held with a metallic plate through a release film. They were laminate-pressed at a temperature of 120° C. and a pressure of 10 kgf/cm² for a time of 15 minutes, and further at a temperature of 170° C. and a pressure of 40 kgf/cm² for a time of 60 minutes to obtain a laminate having a plate thickness of 0.2 mm. Subsequently, the surface of the laminate was roughened with an alkaline permanganate oxidizing agent, and a conductor layer was formed on the whole surface by electroless plating and electroplating. Then, an annealing treatment was further conducted at a temperature of 180° C. for a time of 60 minutes. The peel strength of the resulting conductor layer was 0.7 kgf/cm. The thus-obtained multilayer printed circuit board was soldered at a temperature of 260° C. for a time of 60 seconds, and the solder heat resistance was observed. Consequently, abnormalities such as delamination of the resin or peeling of the conductor were not found.

### Comparative Example 4

A four-layer printed circuit board was obtained in the same manner as in Example 4 using the adhesive film obtained in Comparative Example 2. The peel strength of the resulting conductor layer was 0.2 kgf/cm. The thus-obtained multilayer printed circuit board was soldered at a temperature of 260° C. for a time of 60 seconds, and the solder heat resistance was observed. Consequently, since the peel strength was low, abnormality such as peeling of the conductor was found.

Measurement of a Curing Behavior of Resin Compositions

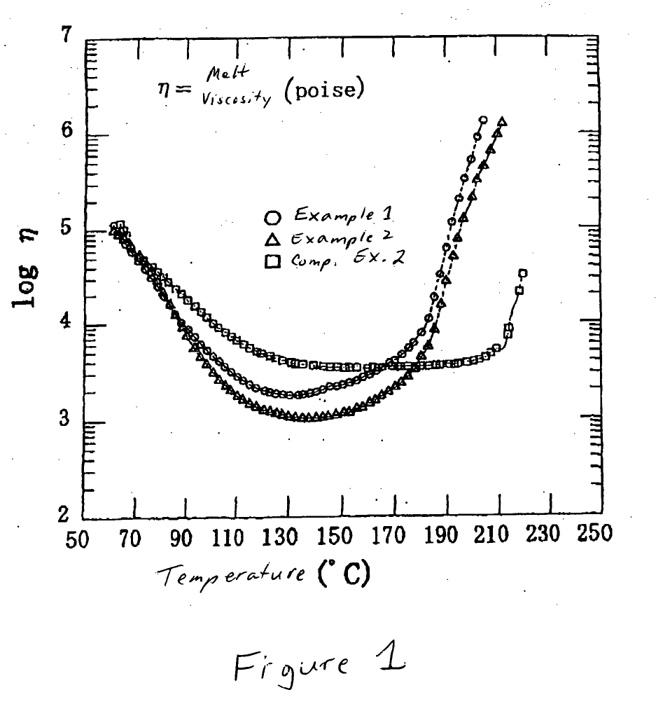

The dynamic viscoelasticity of the epoxy resin compositions of the adhesive films obtained in Examples 1 and 2 and Comparative Example 2 were measured using Rheosol-G3000 manufactured by K.K. U. B. M. The measurement results of Examples 1 and 2 and Comparative Example 2 are shown in FIG. 1. The measurement was conducted at a rate of temperature rise of 5° C./min from an initial temperature of 60° C., and at a measurement interval temperature of 2.5° C., and a frequency of 1 Hz/deg. As is clear from FIG. 1, in Examples 1 and 2, an increase in melt viscosity caused by curing was observed from approximately 130° C., and the melt viscosity was abruptly increased at more than 170° C. Meanwhile, in Comparative Example 2 in which the phenoxy resin was absent, an increase in viscosity was not observed up to approximately 200° C. This reveals that the resin compositions in Examples 1 and 2 allow the curing at a low temperature. Melt viscosity values at respective temperatures are shown in Tables 2 to 4.

TABLE 2
Temperature-melt viscosity value of the resin composition in Example 1

| Temperature (° C.) | Melt viscosity (poise) |
|---|---|
| 90 | approximately 9,020 |
| 100 | approximately 4,650 |
| 110 | approximately 2,880 |
| 120 | approximately 2,050 |
| 130 | approximately 1,780 |

TABLE 3
Temperature-melt viscosity value of the resin composition in Example 2

| Temperature (° C.) | Melt viscosity (poise) |
|---|---|
| 90 | approximately 7,410 |
| 100 | approximately 3,210 |
| 110 | approximately 1,810 |
| 120 | approximately 1,290 |
| 130 | approximately 1,070 |

TABLE 4
Temperature-melt viscosity value of the resin
composition in Comparative Example 2

| Temperature (° C.) | Melt viscosity (poise) |
|---|---|
| 90 | approximately 18,100 |
| 100 | approximately 10,300 |
| 110 | approximately 6,670 |
| 120 | approximately 4,850 |
| 130 | approximately 3,950 |

Evaluation of a Pot Life of Resin Compositions

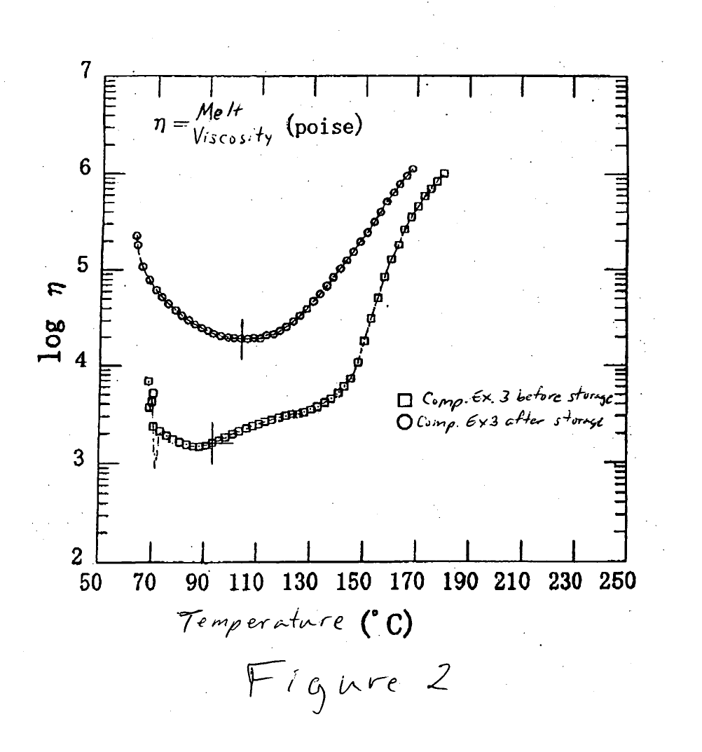

The dynamic viscoelasticity of the epoxy resin composition of the adhesive film obtained in Comparative Example 3 was measured in the foregoing manner. Further, the epoxy resin compositions of the adhesive films obtained in Examples 1 and 2 and Comparative Examples 2 and 3 were stored at room temperature for 3 days, and then the dynamic viscoelasticity was measured in the foregoing manner. Regarding Comparative Example 3, the results before and after the storage are shown in FIG. 2. Regarding the resin compositions of Examples 1 and 2 and Comparative Example 2, a curve which was approximately the same as before storage was drawn (not shown), and the pot life was found to be excellent. Meanwhile, in Comparative Example 3 using the phenolic resin as a curing accelerator, the melt viscosity of the resin was extremely increased after three days of storage at room temperature, and the pot life was poor. Accordingly, it was found that the resin composition was not suitable for use as a resin composition for an adhesive film or a prepreg. The results in FIGS. 1 and 2 reveal that in the epoxy resin compositions of the adhesive films obtained in Examples 1 and 2, the curing acceleration effect and the pot life are consistent owing to the phenoxy resin.

Evaluation of Electrical Properties

The surfaces of the epoxy resin composition of the adhesive film obtained in each of Examples 1 and 2 and Comparative Example 2 were overlaid, and vacuum-laminated. After the support film was peeled, the surfaces of the resin composition were vacuum-laminated several times in like manner to form a sixteen-layer resin composition sample with a 60-μm resin, the sample having a thickness of approximately 1 mm. This sample was thermally cured at a temperature of 100° C. for a time of 30 minutes and further at a temperature of 180° C. for a time of 90 minutes. Using this sample, the dielectric constant and the dielectric dissipation factor were measured according to IPC-TM 650 2.5.5.9. The results of the values measured at room temperature (23° C.) and a measurement frequency of 1 GHz were shown in Table 5.

TABLE 5

| | | | Comparative |
|---|---|---|---|
| | Example 1 | Example 2 | Example 2 |
| Dielectric constant | 3.1 | 3.2 | 3.3 |
| Dielectric | 0.010 | 0.012 | 0.019 |
| dissipation factor | | | |

From the results in Table 5, it is seen that the resin compositions of the present invention exhibit the excellent electrical properties (dielectric dissipation factor of less than 0.015 at 1 GHz and 23° C.) under the curing condition of 180° C. Meanwhile, in Comparative Example 2, it is found that the cured product of the resin composition shows a high dielectric dissipation factor in spite of using a polysulfone having a lower value than the phenoxy resin for the dielectric dissipation factor of the resin itself.

As is clear from Examples 4 to 6 and Comparative Example 4, the adhesive film and the prepreg of the present invention can form a copper copper-plated layer having excellent adhesion by roughening with an oxidizing agent, and a multilayer printed circuit board can easily be obtained by the build-up method.

Industrial Applicability

The adhesive film and the prepreg of the present invention are excellent in pot life and curing properties and provide excellent electrical properties after curing. Since it is possible to roughen the cured product with an oxidizing agent after curing, a conductor layer can be formed by plating. The present adhesive films and prepregs are excellent for industrially producing a multilayer printed circuit board by the build-up method in particular.

Obviously, numerous modifications and variations of the present invention are possible in light of the above teachings. It is therefore to be understood that, within the scope of the appended claims, the invention may be practiced otherwise than as specifically described herein.

All patents and other references mentioned above are incorporated in full herein by this reference, the same as if set forth at length.

1. An adhesive film, comprising a layer of an epoxy resin composition formed on a support film, wherein said epoxy resin composition comprises the following components (A) to (C):
(A) an aromatic epoxy resin having two or more epoxy groups in a molecule;
(B) an aromatic cyanate compound having two or more cyanato groups in a molecule; and
(C) a phenoxy resin having a weight-average molecular weight of from 5,000 to 100,000.

2. The adhesive film of claim 1, wherein said phenoxy resin as component (C) is a phenoxy resin having a biphenyl skeleton.

3. The adhesive film of claim 2, wherein said epoxy resin composition after thermal curing has a dielectric dissipation factor of 0.015 or less as determined by measurement conditions of a measurement frequency of 1 GHz and a temperature of 23° C.

4. The adhesive film of claim 2, wherein the ratio between the epoxy groups of the aromatic epoxy resin as component (A) and the cyanato groups of the aromatic cyanate compound as component (B) in the epoxy resin composition is from 1:0.5 to 1:3, and the phenoxy resin as component (C) is present in an amount of from 3 to 40 parts by weight per 100 parts by weight of the total weight of components (A) and (B).

5. The adhesive film of claim 1, wherein said epoxy resin composition after thermal curing has a dielectric dissipation factor of 0.015 or less as determined by measurement conditions of a measurement frequency of 1 GHz and a temperature of 23° C.

6. The adhesive film of claim 5, wherein the ratio between the epoxy groups of the aromatic epoxy resin as component (A) and the cyanato groups of the aromatic cyanate compound as component (B) in the epoxy resin composition is from 1:0.5 to 1:3, and the phenoxy resin as component (C) is present in an amount of from 3 to 40 parts by weight per 100 parts by weight of the total weight of components (A) and (B).

7. The adhesive film of claim 1, wherein the ratio between the epoxy groups of the aromatic epoxy resin as component (A) and the cyanato groups of the aromatic cyanate compound as component (B) in the epoxy resin composition is from 1:0.5 to 1:3, and the phenoxy resin as component (C) is present in an amount of from 3 to 40 parts by weight per 100 parts by weight of the total weight of components (A) and (B).

8. The adhesive film of claim 1, wherein said aromatic cyanate compound having two or more cyanato groups in the molecule comprises at least one aromatic cyanate compound selected from the group consisting of bisphenol A diisocyanate, polyphenol cyanate (oligo(3-methylene-1,5-phenylene cyanate), 4,4′-methylenebis (2,6-dimethylphenyl cyanate), 4,4′-ethylidenediphenyl dicyanate, hexafluorobisphenol A dicyanate, a prepolymer obtained by partially triazinating bisphenol A diisocyanate, a prepolymer obtained by partially triazinating polyphenol cyanate (oligo(3-methylene-1,5-phenylene cyanate), a prepolymer obtained by partially triazinating 4,4′-methylenebis (2,6-dimethylphenyl cyanate), a prepolymer obtained by partially triazinating 4,4′-ethylidenediphenyl dicyanate, a prepolymer obtained by partially triazinating hexafluorobisphenol A dicyanate, and mixtures thereof.

9. A multilayer printed circuit board, comprising an insulation layer which is formed of the adhesive film of claim 1.

10. A method for making a multilayer printed circuit board, comprising:
(a) laminating an adhesive film of claim 1 on a circuit substrate under pressing and heating conditions;
(b) thermally curing said epoxy resin composition of said adhesive film laminated on said circuit substrate to form an insulation layer; and
(c) forming a conductor layer by plating.

11. The method of claim 10, further comprising removing said support film.

12. The method of claim 11, wherein said support film is removed after said laminating and before said thermally curing.

13. The method of claim 11, wherein said support film is removed after said thermally curing.

14. The method of claim 10, further comprising roughening the surface of said insulation layer with an oxidizing agent as required prior to said forming a conductor layer.

15. A multilayer printed circuit board, which is made by the method of claim 10.

16. A prepreg, comprising a sheet-like reinforcing base material made of a fiber which is impregnated with an epoxy resin composition, which comprises the following components (A) to (C);
(A) an aromatic epoxy resin having two or more epoxy groups in a molecule;
(B) an aromatic cyanate compound having two or more cyanato groups in a molecule; and
(C) a phenoxy resin having a weight-average molecular weight of from 5,000 to 100,000.

17. The prepreg of claim 16, wherein said phenoxy resin as component (C) is a phenoxy resin having a biphenyl skeleton.

18. The prepreg of claim 17, wherein said epoxy resin composition after thermal curing has a dielectric dissipation factor of 0.015 or less as determined by measurement conditions of a measurement frequency of 1 GHz and a temperature of 23° C.

19. The prepreg of claim 17, wherein the ratio between the epoxy groups of the aromatic epoxy resin as component (A) and the cyanato groups of the aromatic cyanate compound as component (B) in the epoxy resin composition is from 1:0.5 to 1:3, and the phenoxy resin as component (C) is present in an amount of from 3 to 40 parts by weight per 100 parts by weight based on the total weight of components (A) and (B).

20. The prepreg of claim 16, wherein said epoxy resin composition after thermal curing has a dielectric dissipation factor of 0.015 or less as determined by measurement conditions of a measurement frequency of 1 GHz and a temperature of 23° C.

21. The prepreg of claim 20, wherein the ratio between the epoxy groups of the aromatic epoxy resin as component (A) and the cyanato groups of the aromatic cyanate compound as component (B) in the epoxy resin composition is from 1:0.5 to 1:3, and the phenoxy resin as component (C) is present in an amount of from 3 to 40 parts by weight per 100 parts by weight based on the total weight of components (A) and (B).

22. The prepreg of claim 16, wherein the ratio between the epoxy groups of the aromatic epoxy resin as component (A) and the cyanato groups of the aromatic cyanate compound as component (B) in the epoxy resin composition is from 1:0.5 to 1:3, and the phenoxy resin as component (C) is present in an amount of from 3 to 40 parts by weight per 100 parts by weight based on the total weight of components (A) and (B).

23. The prepreg of claim 16, wherein said aromatic cyanate compound having two or more cyanato groups in the molecule comprises at least one aromatic cyanate compound selected from the group consisting of bisphenol A diisocyanate, polyphenol cyanate (oligo(3-methylene-1,5-phenylene cyanate), 4,4′-methylenebis (2,6-dimethylphenyl cyanate), 4,4′-ethylidenediphenyl dicyanate, hexafluorobisphenol A dicyanate, a prepolymer obtained by partially triazinating bisphenol A diisocyanate, a prepolymer obtained by partially triazinating polyphenol cyanate (oligo(3-methylene-1,5-phenylene cyanate), a prepolymer obtained by partially triazinating 4,4′-methylenebis (2,6-dimethylphenyl cyanate), a prepolymer obtained by partially triazinating 4,4′-ethylidenediphenyl dicyanate, a prepolymer obtained by partially triazinating hexafluorobisphenol A dicyanate, and mixtures thereof.

24. A multilayer printed circuit board, comprising an insulation layer which is formed of the prepreg of claim 16.

25. A method for making a multilayer printed circuit board, comprising:
(a) laminating a prepreg according to claim 16 on a circuit substrate under pressing and heating conditions to form an insulation layer; and
(b) forming a conductor layer on the surface of said insulation layer by plating.

26. The method of claim 25, further comprising roughening the surface of said insulation layer with an oxidizing agent before said forming a conductor layer.

27. A multilayer printed circuit board which is made by the method of claim 25.
